(19) United States
(12) Patent Application Publication
(10) Pub. No.: US 2025/0184137 A1
(43) Pub. Date: Jun. 5, 2025

(54) COMPUTER SYSTEMS AND METHODS FOR SECURE AND SCALABLE DIGITAL ASSET CUSTODIAN

(71) Applicant: Bullish Global, Grand Cayman (KY)

(72) Inventors: Hui Fang, Singapore (SG); Santhosh Kumaraswamy, Rocky Point, NY (US); Mohammad Nauman, Peoria, AZ (US); Mothusi Sean Majinda, Wanchai (HK); Yonathan Widya Adipradana, Singapore (SG); Qing Yang, Willamsburg, VA (US)

(21) Appl. No.: 18/969,223

(22) Filed: Dec. 4, 2024

Related U.S. Application Data
(60) Provisional application No. 63/605,944, filed on Dec. 4, 2023.

(51) Int. Cl. H04L 9/14

(52) U.S. Cl. CPC H04L 9/14

(57) ABSTRACT

Embodiments described herein relate to computer systems and methods for digital asset custodian that seamlessly integrates off-chain multi-party computation (MPC) signing with on-chain party identity authentication. The system comprises a service provider node, multiple computation nodes equipped with robust secure hardware, and a Blockchain accessible to all participating nodes. The nodes deliver a threshold signing service with utmost security—ensuring that no single node can recover the private key, while simultaneously recording and mutually authenticating each node's identity on-chain. The system boasts intrinsic support for hierarchical address creation and signing, facilitated by an enhanced protocol. Its scalability, particularly in the quantity of computation nodes, is complemented by efficient communication tailored to the demands of the MPC protocol.

### CROSS REFERENCE TO RELATED APPLICATION(S)

The application claims priority to and the benefit of U.S. provisional patent application No. 63/605,944 entitled “COMPUTER SYSTEMS AND METHODS FOR SECURE AND SCALABLE DIGITAL ASSET CUSTODIAN,” filed Dec. 4, 2023, the entire contents of which is hereby incorporated by reference herein.

### FIELD

The improvements generally relate to the field of cryptography, distributed computer architectures, distributed systems, information security, executable programs, smart contract code, trading platforms, Blockchains, and Blockchain infrastructure.

### INTRODUCTION

Distributed computer systems can implement decentralized exchange platforms. However, distributed systems can pose challenges for securing information, managing private keys, and signing transactions for trading and transfer of cryptocurrencies. For example, losing the private key or allowing it to be stored in one location may make is susceptible to hackers.

Compounding this issue is that transactions in decentralized exchange platforms may be irreversible. Accordingly, loss of a private key or data breach incidents may make the funds stored thereon susceptible to theft or loss.

There exists a need for improved decentralized exchange platforms. Further, improvements in the field of private key management for decentralized exchange platforms is desired.

### SUMMARY

Embodiments described herein relate to digital asset custody, information security, private key management, and transaction signing for trading and transfer of cryptocurrencies on decentralized exchange platforms.

In an aspect, embodiments described herein provide a computer system for digital asset custodian that integrates off-chain multi-party computation (MPC) signing with on-chain party identity authentication, wherein the computer system comprises a service provider node, a plurality of computation nodes, and blockchain infrastructure accessible to all participating nodes, each of the plurality of computation nodes with secure, tamper-resistant hardware.

In some embodiments, a computation node stores an MPC key share and a PKI private key in its secure hardware, wherein the blockchain stores a public key for the computation node, a location for the MPC key share for the computation node, and a location for the PKI private key for the computation node, the location referencing the computation node

In an aspect, embodiments described herein provide a digital asset custodian system and method that seamlessly integrates off-chain multi-party computation (MPC) signing with on-chain party identity authentication. In some embodiments, the system comprises a service provider node, multiple computation nodes equipped with robust secure hardware, and is underpinned by a Blockchain accessible to all participating nodes. Through collaborative efforts, these nodes deliver threshold signing service with utmost security to ensure that no single node can recover the private key, while simultaneously recording and mutually authenticating each node's identity on-chain. The system boasts intrinsic support for hierarchical address creation and signing, facilitated by an enhanced protocol. Its scalability, particularly in the quantity of computation nodes, is complemented by efficient communication tailored to the demands of the MPC protocol. Embodiments described herein may be useful for cryptocurrency custodian institutions catering to a large customer base and deploying services in the cloud.

In an aspect, embodiments described herein provide a distributed system incorporating a service node, computation nodes, and a Blockchain to execute the MPC protocol, delivering secure and efficient custodian functions such as key management and message signing. Private keys or key shares can be stored in secure enclaves on each node, with relevant public keys registered on a verifiable public Blockchain. The system can provide a dedicated service node for protocol coordination, message routing, and service provision to enhance transparency. The system improves scalability as the number of computation nodes can expand while maintaining linear communication costs. Embodiments described herein provide a system with heightened security through verified identities and end-to-end encryption for all inter-entity communications.

In an aspect, there is provided a computer system for digital asset custodian that integrates off-chain multi-party computation (MPC) signing with on-chain party identity authentication. The computer system includes a service provider node, a plurality of computation nodes, and blockchain infrastructure accessible to all participating nodes. Each of the plurality of computation nodes having robust secure hardware and/or secure, tamper-resistant hardware. The hardware may be secure and tamper-resistant because it operates within Trusted Platform Modules (TPMs). TPMs can protect cryptographic keys and sensitive operations by ensuring key shares remain inaccessible outside the module. They employ tamper detection and response mechanisms, such as wiping sensitive data upon unauthorized access attempts, to enhance security. This can aligns the system with established industry practices for cryptographic integrity and resistance to physical tampering.

In some embodiments, a computation node stores a key share (e.g., an MPC key share) and a private key (e.g., a PKI private key) in its secure hardware. The blockchain stores a public key for the computation node, a location for the key share for the computation node, and a location for the private key (e.g., the PKI private key) for the computation node, the location referencing the computation node.

In some embodiments, the system further includes a user device having a wallet application. The service node provides a wallet service for the wallet application. The wallet service providing key generation and signing.

In some embodiments, the user device transmits an address creation request to the service node and receives an address creation response from the service node. The address creation response includes a wallet address. The service node relays the request to the computation nodes to generate the wallet address using MPC DKG.

In some embodiments, the user device transmits a transaction signing request to the service node and receives a transaction signing response from the service node. The transaction signing request includes a transaction hash and wallet address. The transaction signing response includes a signed transaction. The service node relays the request to the computation nodes to generate a signature for the signed transaction.

In some embodiments, the nodes deliver a threshold signing service with security to ensure that no single node can recover the private key, while simultaneously recording and mutually authenticating each node's identity on-chain.

In some embodiments, the service provider node implements hierarchical address creation and signing using an enhanced MPC protocol.

In some embodiments, the quantity of computation nodes scales and the system uses efficient communication in response to the demands of the MPC protocol.

In some embodiments, the blockchain infrastructure executes the MPC protocol delivering secure and efficient custodian functions such as key management and message signing.

In some embodiments, the distributed system, comprising a service node, computation nodes, and blockchain infrastructure, executes the MPC protocol, with the blockchain infrastructure facilitating the storage and verification of public keys, delivering secure, and efficient custodian functions such as key management and message signing.

In some embodiments, the private keys (e.g., the PKI private keys) or key shares (e.g., the MPC key shares) are stored in secure enclaves on each node, with relevant public keys registered on the verifiable blockchain infrastructure. A user can initiate a transaction signed with their private key to create a digital signature that is unique to the transaction and the private key. The nodes on the blockchain can use the associated public key to verify the digital signature and confirm that the transaction was verified by the user with the private key. The blockchain infrastructure can also use hash functions to protect the data and ensure data integrity.

The blockchain can facilitate the verification of public keys by acting as a centralized, immutable registry. Public keys can first be authenticated and added to the blockchain through a secure whitelisting process which may ensure that only authorized keys are registered. The same blockchain can be used for both storing these public keys and recording transactions. During transaction verification, nodes can reference the public keys stored on the blockchain to validate the digital signature associated with the transaction. This approach can ensure consistency, data integrity, and security while leveraging the blockchain's tamper-proof and transparent nature.

In some embodiments, the service provider node implements protocol coordination, message routing, and service provision to enhance transparency.

In some embodiments, the system provides security through verified identities and end-to-end encryption for all inter-entity communications.

In some embodiments, the system provides a scalable and efficient communication design of the MPC TSS protocol.

In some embodiments, the system uses a trustless dealer.

In some embodiments, the system supports HD standard-compatible wallets within the MPC protocol.

In some embodiments, the system provides publicly retrievable identities on-chain for all nodes.

In some embodiments, the system uses authenticated and non-tamperable protocol messages.

In some embodiments, the service node is implemented by a processing system that includes one or more processors and one or more memories coupled with the one or more processors, the one or more memories storing instructions for the off-chain MPC signing with on-chain party identity authentication.

In an aspect, there is provided a computer implemented method for digital asset custodian that integrates off-chain multi-party computation (MPC) signing with on-chain party identity authentication. The method including transmitting, by a service node, seed shares to a plurality of computation nodes equipped with robust secure hardware, generating, at each of the plurality of computation nodes, a key share and a private key using MPC DKG and storing the key share and private key in the robust secure hardware of the respective computation node, registering corresponding public keys on a blockchain, signing, at a computation node of the plurality of computation nodes, a message or transaction using a signature generated by combining signature shares of the computation nodes by MPC signing, and transmitting the signed message or transaction. The key shares are derived by the service node from a master seed. All key shares are organized into a hierarchical tree structure containing multiple address indices.

In an aspect, there is provided a computer implemented method for digital asset custodian that integrates off-chain multi-party computation (MPC) signing with on-chain party identity authentication. The method includes transmitting, by a service node, seed shares to a plurality of computation nodes each equipped with secure, tamper-resistant hardware, generating, at each of the plurality of computation nodes, a key share and a private key using MPC DKG and storing the key share and private key in the robust secure hardware of the respective computation node, storing, on a blockchain for a respective computation node, a public key for the computation node, a location for the MPC key share for the computation node, and a location for the PKI private key for the computation node, signing, at a computation node of the plurality of computation nodes, a message or transaction using a signature generated by combining signature shares of the computation nodes by MPC signing, and transmitting the signed message or transaction. Each of the plurality of computation nodes stores an MPC key share and a PKI private key in its secure, tamper-resistant hardware. The MPC key share is derived by the service node from a master seed. All key shares are organized into a hierarchical tree structure containing multiple address indices.

In some embodiments, the method further includes providing, by the service node, a wallet service for a wallet application on a user device for providing key generation and signing, receiving an address creation request and providing an address creation response, the address creation response comprising a wallet address, and relaying, by the service node, the request to the computation nodes to generate the wallet address using MPC DKG.

In an aspect, there is provided a non-transitory machine readable medium having stored thereon a plurality of instructions that, when executed by at least one computing device, cause the at least one computing device to perform the method for digital asset custodian that integrates off-chain multi-party computation (MPC) signing with on-chain party identity authentication. The method includes transmitting seed shares to a plurality of computation nodes equipped with secure, tamper-resistant hardware, generating, at each of the plurality of computation nodes, a key share and a private key using MPC DKG and storing the key share and private key in the robust secure hardware of the respective computation node, signing, at a computation node of the plurality of computation nodes, a message or transaction using a signature generated by combining signature shares of the computation nodes by MPC signing, and transmitting the signed message or transaction. The key shares are derived by the service node from a master seed. All key shares are organized into a hierarchical tree structure containing multiple address indices.

Embodiments described herein can improve regulatory compliance using on-chain identity authentication, transparency, data security, and key management. On-chain identity authentication can provide an auditable mechanism for verifying parties involved in transactions. Transparency can be provided by the decentralized architecture and the service node which may aide in ensuring accountability and visibility into key operations. Improved data security can be provided by end-to-send encryption and tamper-proof messaging to align with global standards for protecting sensitive information. The systems described herein may ensure that no single party can reconstruct private keys which may align with best practices in data custody.

The systems described herein may be scalable. For example, in increasing the number of computation nodes, the system can expand while maintaining linear communication costs. Furthermore, the system may be configured to handle an increasing number of nodes and transactions efficiently.

Many further features and combinations thereof concerning embodiments described herein will appear to those skilled in the art following a reading of the instant disclosure.

### DESCRIPTION OF THE FIGURES

In the figures,

FIG. 1A shows a schematic diagram of a secure MPC-TSS system, according to some embodiments.

FIG. 1B shows a schematic diagram of a distributed computer system for secure MPC-TSS, according to some embodiments.

FIG. 2 shows a schematic diagram of a wallet address creation session, according to some embodiments.

FIG. 3 shows a schematic diagram of a transaction signing session, according to some embodiments.

FIG. 4 shows a schematic diagram of HD key generation and derivation flow with MPC, according to some embodiments.

FIG. 5 shows a schematic diagram of a PKI messages, according to some embodiments.

FIG. 6 illustrates an example method for secure MPC-TSS, according to some embodiments.

FIG. 7 is a schematic diagram of computing device components.

### DETAILED DESCRIPTION

Embodiments described herein provide digital asset custodian systems and methods that seamlessly integrates off-chain multi-party computation (MPC) signing with on-chain party identity authentication.

### Multi-Party Computation

MPC is in the field of cryptography that enable parties to jointly compute a function over their inputs while keeping those inputs private. In MPC, a set of parties that do not trust each other try to jointly compute a function over their inputs, and it is guaranteed that each party only obtains its own computational results, and the input and output data of any other party cannot be inferred from the interaction data during the computation.

For example, each participant's input can be divided into shares that can be distributed among the participants. No single participant has enough information to reconstruct the original input. The participants perform computations on their shares without revealing their actual inputs. This ensures that the privacy of each participant's data is maintained throughout the process. After the computation, the results are combined to produce the final output. The inputs remain private, but the desired computation is completed.

The MPC method can be extended to digital asset custodian use cases. This can help protect sensitive information, meet regulatory requirements for data privacy, and reduce risk of data breaches by not exposing data to any single party.

In Blockchain, a transaction can be approved by verifying its signature. A single private key is an example way of generating a valid signature, and it is usually related to an address. Alternatively, there is a way to generate signatures that do not give one party all the power, by splitting the generation process of signatures between two or more parties. This can be achieved using secure multi-party computation, where two or more parties collaborate to generate a valid blockchain signature. During the MPC protocol, each party has its own key share, and these key shares each generate a partial signature; all partial signatures are then combined into a single valid signature. The real private key is never shared and does not need to appear.

A complete MPC protocol can support the following example processes: (1) Distributed Key Generation (DKG) and (2) Signing.

Threshold Signature Scheme (TSS) Vs. Multi-Signature

The MPC-based threshold signature scheme (TSS) divides the private key into multiple “key shares” in a way that each party holds only its own key share, while only a subset of key shares are required when generating a legitimate signature. The underlying cryptography involves secret sharing algorithms, one example of which is Shamir-Secret-Sharing with (t, n) threshold based on Lagrange interpolation.

Multi-signature happens on-chain and requires the chain itself to implement and support the signature process, either in native script (e.g. Bitcoin) or by smart contract (e.g. Ethereum).

TSS does not depend on a specific chain, and can be done off-chain. The transaction signed by TSS will not look different from ordinary ones, because its single signature is related to one private key only.

### Hierarchical Deterministic Wallets

Hierarchical Deterministic (HD) wallets provide a mechanism to generate a lot of private keys deterministically from a single master key. That way the system only needs to backup the master key and later can restore all derived keys given the single master key. All derived keys can be organized into a hierarchical tree structure containing multiple address indices.

Embodiments described herein relate to digital asset custody, information security, private key management, and transaction signing for trading and transfer of cryptocurrencies on decentralized exchange platforms.

Embodiments described herein can comply with regulatory requirements through the use of on-chain identity authentication, transparency, data security, and key management. On-chain identity authentication can provide an auditable mechanism for verifying parties involved in transactions. Transparency can be achieved through the service node (as described in greater detail below) and decentralized architecture which may aide in ensuring accountability and visibility into key operations. Data security can be achieved with end-to-send encryption and tamper-proof messaging that align with global standards for protecting sensitive information. The systems described herein may ensure that no single party can reconstruct private keys which may align with best practices in data custody.

The systems described herein may be scalable. For example, in increasing the number of computation nodes, the system can expand while maintaining linear communication costs. Furthermore, the system may be configured to handle an increasing number of nodes and transactions efficiently which make it appropriate for both small-scale and enterprise-level operations.

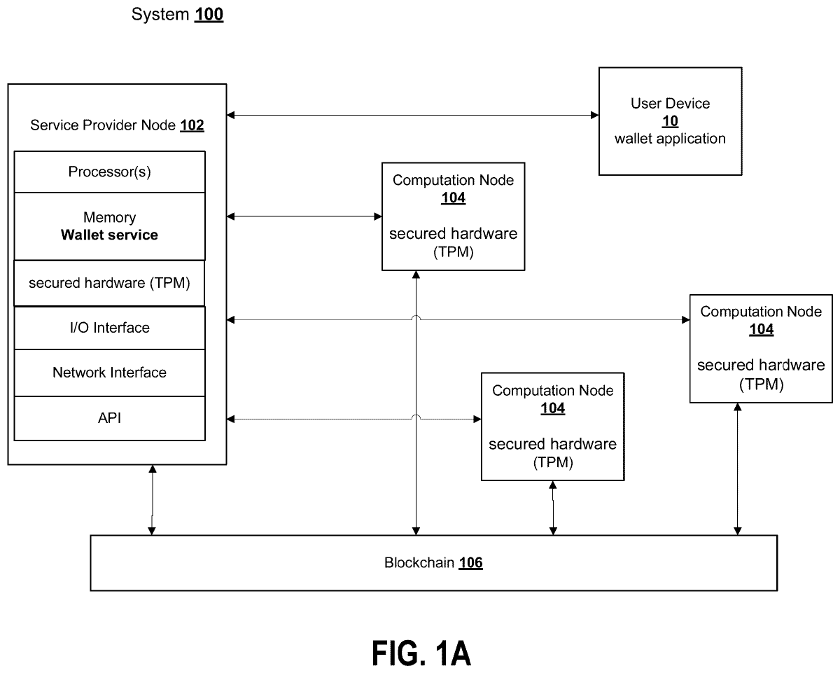

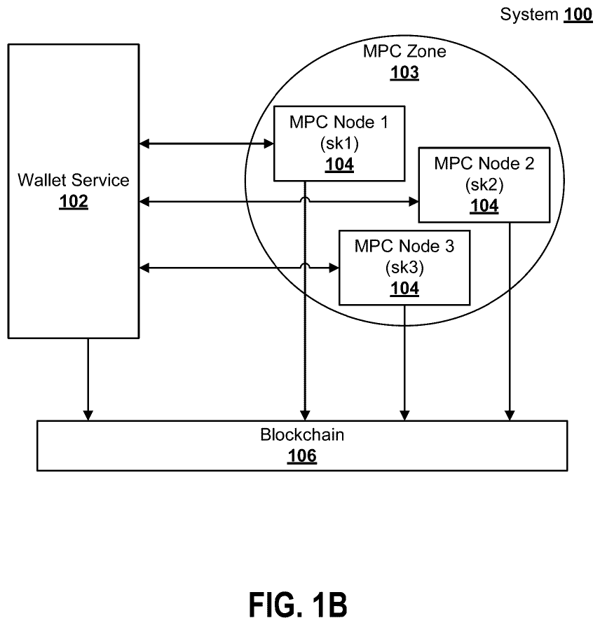

FIGS. 1A and 1B show schematic diagrams of a secure multi-party computation (MPC) threshold signature scheme (TSS) system 100, according to some embodiments.

In an aspect, the system 100 provides a digital asset custodian that seamlessly integrates off-chain MPC signing with on-chain party identity authentication. In some embodiments, the system 100 has one or more service provider nodes 102 (which may also be referred to herein as service node 102 or wallet service 102), multiple computation (MPC) nodes 104 equipped with robust secure hardware and/or secure, tamper-resistant hardware, and a Blockchain 106 accessible to all participating nodes. The MPC nodes 104 may be arranged into MPC zones 103 in, for example, sets of three. The service provider node 102 can provide a wallet service. The nodes 102, 104 deliver a threshold signing service with improved security to ensure that no single node can recover the private key, while simultaneously recording and mutually authenticating each node's identity on-chain. The system 100 can provide intrinsic support for hierarchical address creation and signing, facilitated by an enhanced protocol. The system 100 is scalable, such as in the quantity of computation nodes 104, which is complemented by efficient communication tailored to the demands of the MPC protocol.

The system 100 can provide both off-chain MPC signing and on-chain account authentication.

In the example diagrams of FIGS. 1A and 1B, the system 100 has <n> MPC nodes 104, <1> service provider node 102, and <1> public accessible Blockchain 106. All <n> MPC nodes 104 can form a group achieving threshold signing service with <t, n> configuration (e.g., 2-of-3 configuration). This can be done by an MPC protocol such as TSS for Elliptic Curve Digital Signature Algorithm (ECDSA) and Edwards-curve Digital Signature Algorithm (EdDSA).

In some embodiments, the system 100 can choose to increase or decrease the number of MPC nodes 104. This can thus increase the capability of processing larger amount of transaction signing requests from users. System 100 can determine whether to increase or decrease the number of MPC nodes 104 (and by how many MPC nodes) based on a number of transaction signing requests, and then trigger the corresponding increase or decrease of the number of MPC nodes 104.

The system 100 can support scalability by allowing the addition or removal of MPC nodes 104 as needed, provided that new nodes 104 are properly configured and their public keys are registered on the blockchain 106. System 100 can register new MPC nodes 104 and their public keys, and also configure the new MPC nodes 104. The MPC protocol itself is cryptographically focused and does not inherently manage wallet-related logic, such as wallet mapping or tracking. While the MPC nodes 104 can be involved in operations like deposit address generation or transaction signing, they do so under the orchestration of the service provider node 102 which can manages wallet context and routing.

The service provider node 102 can acts as the session manager, coordinating all communications with the MPC nodes 104 for Distributed Key Generation (DKG) and transaction signing. This centralized coordination ensures that transaction signing requests are routed to the appropriate nodes 104.

Additionally, the MPC nodes 104 can be deployed in a high-availability setup with redundancy. For example, multiple MPC zones 103 may each have a set of MPC nodes 104. In the event of availability issues, the service provider node 102 can select nodes 104 from different zones 103, such as two nodes 104 from a first zone 103 and one node 104 from a second zone which may ensure operational continuity without compromising security or performance.

As an illustrative example, consider 2-out-of-3. The three MPC nodes 104 can form a fully-functional group. The function of key and address generation may require all three nodes be involved while the function of signing may only need 2-out-of-3 to participate (e.g., threshold signing) and any two of them can perform such threshold signing. For both cases, the involved MPC nodes 104 can communicate with each other only with the coordination of Wallet Service (at service provider node 102).

For example, in a high availability setup with multiple MPC zones 103, the system 100 may have sets of nodes 104 deployed redundantly, such as nodes A, B, and C 104 in each of three MPC zones 103. While these nodes 104 are effectively replicas for redundancy, the MPC protocol treats them as independent participants. Operations like Distributed Key Generation (DKG) or transaction signing may still require the configured threshold of nodes (e.g., 3-of-3 for DKG or 2-of-3 for signing) from a single set in an MPC zone 103.

The service provider node 102 can coordinate the selection of nodes 104 for each operation. If there is an issue in one MPC 103, the service provider node 102 can route operations to nodes 104 in another MPC zone 103 to maintain continuity. This architecture can ensure fault tolerance while adhering to the threshold requirements of the MPC protocol.

As shown in FIG. 1B, each MPC node 104 keeps its private key share <sk> in a safe place. For example, an MPC node 104 can store its private key share <sk> in secured hardware such as trusted platform module (TPM). Wallet Service (at service provider node 102) is responsible for providing key generation and signing service.

The three MPC nodes shown in 104 can form a fully-functional group. The function of key and address generation requires all three nodes be involved; while the function of signing only needs 2-out-of-3 to participate, or called threshold signing, and any two of them can perform such threshold signing. For both case in our system design, the involved MPC nodes communicate with each other only with the coordination of Wallet Service (at service provider node 102).

FIGS. 1A and 1B show two example types of communications: vertical communication and horizontal communication. Horizontal communication can happen between Wallet Service 102 and each MPC node 104 for processing the MPC-TSS protocol. Vertical communication can happen between Wallet Service 102 and Blockchain 106, and between each MPC node 104 and Blockchain 106, to setup a secure message channel for the MPC protocol.

In some embodiments, vertical communication can happen between Wallet Service 102 and Blockchain 106, or between each MPC node of 104 in FIG. 1B (Computation Node 104 in FIG. 1A). They can be used for exchanging public key information among all related entities. The Blockchain 106 may work as a registration place for all other entities' public keys. Each MPC node 104 may need to register its public key to Blockchain 106, and so does Wallet service (at service provider node 102). Afterwards, every entity may be able to query from the Blockchain 106 for the public key of its peers. For example, a first MPC node 104 can query the public key of a second MPC node 104, the public key of a third MPC node 104, and the public key of Wallet Service (at service provider node 102) from the Blockchain 106. Those public keys can then be used in horizontal communications.

The blockchain 106 implementation can leverage public key registration without requiring unique formatting or custom events. Nodes 102, 104 can be registered through transactions that store their public keys immutably on the blockchain 106. The MPC nodes 104 may not perform mining or participate in the consensus mechanism of the blockchain 106; instead, they may rely on the existing blockchain infrastructure 106 for registration and verification purposes. The system may use a private blockchain 106 though the system can be designed to be adaptable to any blockchain platform.

In some embodiments, horizontal communications can be used in the MPC protocol. This may happen, for example, between Wallet Service (at service provider node 102) and each MPC node 104. If an MPC node 104 wants to talk with another MPC node 104, they may rely on Wallet Service (at service provider node 102) to forward the message. Other MPC protocols may specify only the direct communication for MPC pairs, without introducing a role of Service Provider Node 102. The horizontal communications can be further categorized into two types in terms of message destinations: MPC node 104 to MPC node 104 communication, and Wallet Service 102-MPC node 104 communication.

Public keys in this system may not be derived from addresses but may instead be explicitly registered on the blockchain 106 to ensure authenticity and enable mutual verification among entities. Referring to the blockchain 106 allows for immutable and tamper-proof retrieval of public keys, ensuring that MPC nodes 104 and the Wallet Service 102 can securely verify the identities of their peers during horizontal communication. This approach can mitigate the risk of unauthorized key substitution or man-in-the-middle attacks.

### Persisted Data on Each Entity

In some embodiments, persisted data may be stored on each entity (e.g. MPC node 104), for example in secure hardware such as a trusted platform module (TPM). Each MPC node 104 may be equipped with TPM hardware in which a secret key share can be stored. It can also store a public-private key pair, which can be referred to as Public Key Infrastructure (PKI) keys. The PKI private key can be stored in TPM. The service node 102 may maintain its own PKI keys and its private key can be stored in TPM.

The MPC nodes 104 (and the service node 102) can be provisioned as secure instances on confidential computer Virtual Machines (VMs; e.g., isolated and secure environments) provided by, for example, a cloud service, each equipped with, for example, its own Trusted Platform Module (TPM) for tamper-resistant key storage and operations. This setup can ensure a dedicated and controlled environment for protocol execution which can eliminate reliance on user devices or independent nodes in a public network. The system can enhance security and prevents external parties from gaining partial signing authority by isolating key shares within secure hardware.

The MPC nodes 104 store a key share and a private key in its secure hardware. The blockchain 106 stores, for each MPC node 104, a public key for the MPC node 104, a location for the key share for MPC node 104, and a location for the private key for the MPC node 104. The location references the MPC node 104 storing the key share and private key in its secure hardware. In some embodiments, the location can refer to a combination of the machine's IP address and the index reference ID within the secure hardware (e.g., vTPM) that identifies the private key or MPC key share. This can ensures precise identification and secure retrieval of the key material.

In some embodiments, persisted data may be stored on each entity, for example, as data on-chain. All the nodes 104 may have to go through a trusted setup process, in order to register PKI public keys onto the chain. Table 1 describes an exemplary set of the data persisted in node 104 TPM and on-chain, respectively. This is an example for illustrative purposes.

TABLE 1
Persistent data

| Data | Purpose | Location | Secret |
|---|---|---|---|
| Sk1 | Key share for MPC node 1 | MPC node 1, TPM | Yes |
| Sk2 | Key share for MPC node 2 | MPC node 2, TPM | Yes |
| Sk2 | Key share for MPC node 3 | MPC node 3, TPM | Yes |
| Pki_key1 | PKI private key for MPC node 1 | MPC node 1, TPM | Yes |
| Pki_key2 | PKI private key for MPC node 2 | MPC node 2, TPM | Yes |
| Pki_key3 | PKI private key for MPC node 3 | MPC node 3, TPM | Yes |
| Pki_key | PKI private key for Service node | Service node, TPM | Yes |
| Pki_pub1 | PKI public key for MPC node 1 | Chain | No |
| Pki_pub2 | PKI public key for MPC node 2 | Chain | No |
| Pki_pub3 | PKI public key for MPC node 3 | Chain | No |
| Pki_pub | PKI public key for Service node | Chain | No |

### Description of Custodian Workflows

According to some custodian workflows described herein, the service node 102 (e.g., a wallet service) may be responsible to accept requests and return the results to a user 10. The service node 102 may hide details of the MPC protocol from the end user which usually requires a few rounds back and forth with MPC nodes 104 respectively. As seen in FIGS. 1A and 1B, there may not be direct communication between any two MPC nodes 104. Alternatively, all the messages may be routed by the service node 102.

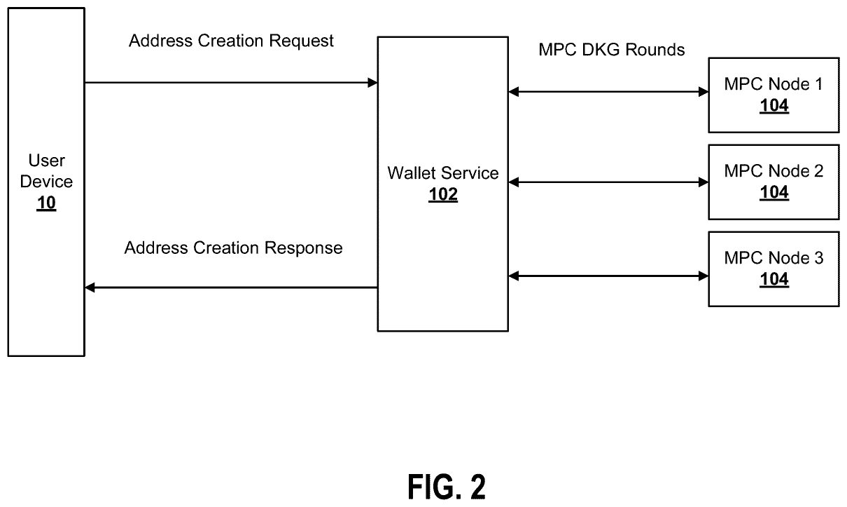

FIG. 2 shows a schematic diagram of a wallet address creation session, according to some embodiments.

Generating a deposit address may be an example of a crypto custodian scenario. The address can be generated by MPC nodes 104 and presented by the service node 102 (e.g., the wallet service) to the user device 10. The user device 10 can have a wallet application that interacts with the wallet service 102. An address creation session can be triggered by the user device 10 (e.g. wallet application) and the request can be forwarded by wallet service 102 to all three MPC nodes 104. The request can contain a unique identifier for the wallet, the desired address path (e.g., as per BIP44 or extended path), and any additional metadata required by the system 100 to generate the address. It need not include the addresses of the 3 MPC nodes 104, as the Wallet Service 102 can manage the coordination and routing of the request to the MPC nodes 104. After MPC DKG (Distributed Key Generation) rounds, there may be an address generated in the response to user device 10 (wallet application). This process can generate a new public-private key pair. Each MPC node 104 can computes its share of the derived private key independently using its stored master key share and the requested address path. These derived shares can then be combined securely to compute the associated public key, allowing the generation of a deposit address without ever reconstructing the full private key. Hierarchical deterministic (HD; described below) key generation can be used to ensure the deterministic generation of private key shares and their associated public keys across all MPC nodes 104 based on the address path. This approach can provide scalability and efficient management of multiple addresses while maintaining compatibility with, for example, BIP44-like standards.

In some embodiments, the wallet application on a user device 10 can interact with Wallet Service 102, but not directly interact with backend MPC nodes 104 nor the blockchain 106. The user device 10 can initiate a request including a request for deposit address or transaction signing to Wallet Service 102. The Wallet Service 102 can then coordinate with MPC nodes 104 to process the protocol messages, and finally return the response to wallet application. The Wallet Service 102 can coordinate between the MPC Nodes 104 by routing protocol messages as per the requirements of the MPC protocol. The Wallet Service 102 does not track the completion status of individual nodes 104; instead, the Wallet Service 102 can ensure messages are delivered to the appropriate nodes 104. Each MPC node 104 independently processes its part of the computation based on the received protocol messages. The protocol itself governs the sequence and dependencies between nodes 104. For operations like address generation, all participating nodes 104 can collaborate, with the final output derived collectively after each node 104 completes its share of the computation.

In some embodiments, a MPC DKG process may require all parties to participate, in an example case 3 MPC nodes 104. Each MPC node 104 can compute its own share of the private key, and then exchange public information to collectively generate a group public key. Firstly, a secret polynomial of degree t can be generated in order to introduce threshold t-out-of-n. Then public share information derived from polynomial can be exchanged over the pairwise authentication and encrypted channel. Each MPC node 104 upon receiving all their public shares from the other MPC nodes 104, may then perform arithmetic addition of the shares to generate a sharing of the shared secret polynomial. Finally, every MPC nodes 104 can broadcast their individual share of the public key by computing the elliptic curve point. Once the broadcast is complete, each MPC node 104 can run a check to verify each individual share of the public key. If the check passes, then the group public key can be generated by an interpolating technique. The group public key can be linked to the private key, and in some embodiments an address can be derived from the public key as well.

The output of the MPC DKG process can be the group public key, which can then be used to derive a deposit address for a wallet. This address is presented to the user through the wallet service 102, which acts as a session manager and interface for wallet operations.

In some embodiments different DKG implementations can be used such as aggregatable DKG or GG protocol, and Lindell protocol, for example. Some protocols can improve the efficiency and security of DKG processes by allowing for the aggregation of partial transcripts, reducing communication overhead, and supporting verifiability and scalability.

In some embodiments, other MPC DKG processes can be used without deviating from the teachings herein. Different MPC DKG processes may use different message flows. For example, the protocol messages originally between MPC nodes 104 may be rerouted and passed through the Wallet Service 102 before reaching the destination, while the same security level is maintained by design.

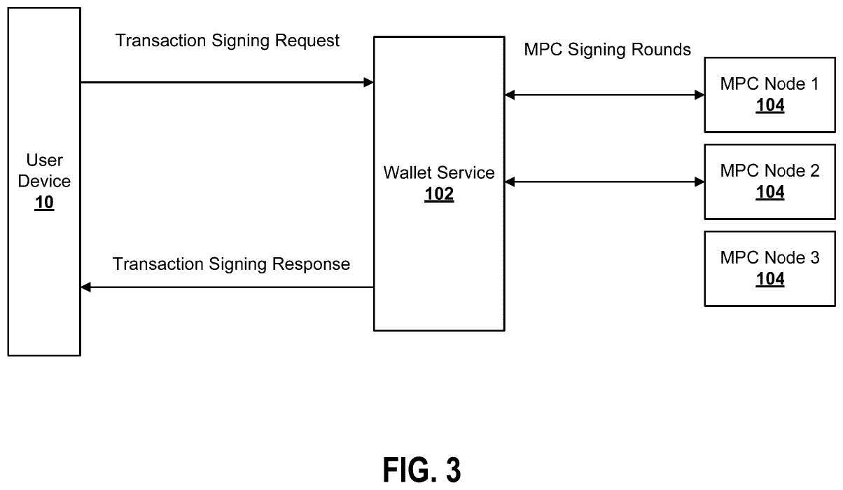

FIG. 3 shows a schematic diagram of a transaction signing session, according to some embodiments.

MPC nodes 104 can also be involved in the transaction signing for the purpose of withdrawing funds from custodian account.

In an exemplary embodiment, the transaction may refer to data to be committed to public Blockchain 106. Each transaction may attach a signature for the whole network to verify and accept. The signature may be generated using a transaction hash and a private key, where the private key can be usually linked to a user account in the custodian scenario. Fund withdrawal from custodian may require the underlying transaction to be signed by the user's private key.

In an example threshold signing case, there can be fewer MPC nodes 104, for example 2-out-of-3 MPC nodes 104, participating in the signing session. The user device 10 (with wallet application) can provide input to wallet service 102, which can include a transaction hash and a wallet address to be used. Wallet service 102 can then sync up with MPC nodes 104 to collect signature shares, and then wallet service 102 can “combine” those two signature shares into a complete signature and can return to the service provider node 102 to user device 10. With a complete signature, the service provider node 102 can further construct a signed transaction based on returned signature and transaction payload. Only the transaction hash may be passed to the MPC nodes 104 through the Wallet Service 102. Accordingly, in the distributed signing process none of MPC nodes 104 may need to know transaction payload except the transaction hash as a message digest. The MPC nodes 104 use this hash to generate their respective signature shares. This ensures that the transaction payload remains unseen by the MPC nodes 104 which may enhance security and privacy.

The Wallet Service 102 can employ a round-robin mechanism for selecting nodes 104 during transaction signing. This can ensure balanced utilization of MPC nodes 104 by distributing requests evenly across them over time. All three nodes 104 can be contacted initially, but only the first two nodes to respond with valid signature shares may used to complete the threshold signing process. This approach optimizes resource usage while maintaining system efficiency and fault tolerance.

### Description of Wallet Structure

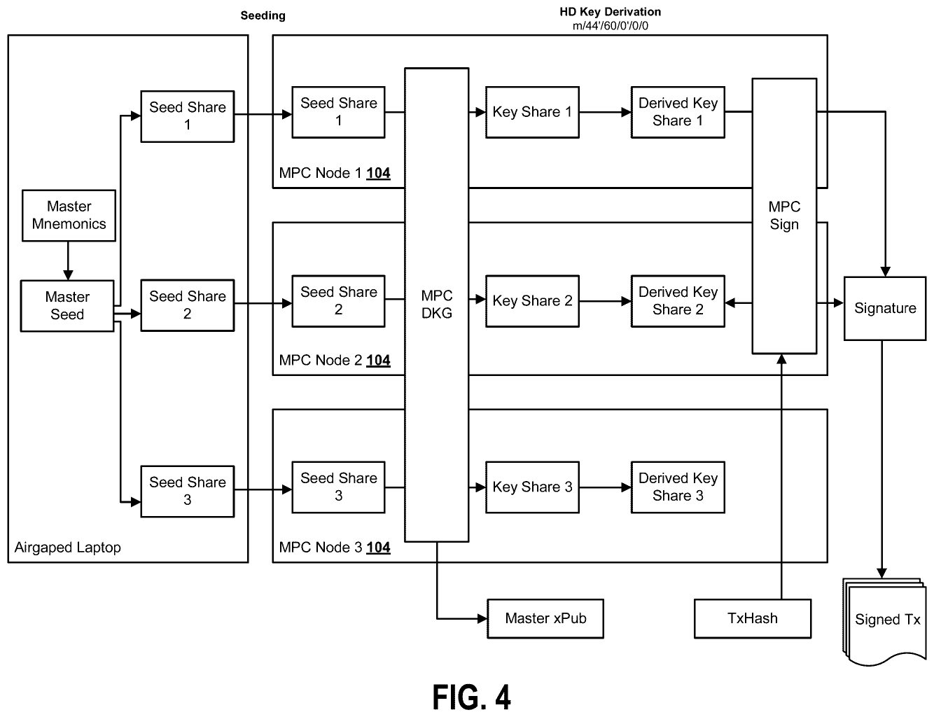

FIG. 4 shows a schematic diagram of Hierarchical Deterministic (HD) key generation and derivation flow with MPC according to some embodiments.

HD wallets can be integrated into the MPC protocol to potentially achieve multiple network and multiple account address generation. The process can include, but is not limited to: master key generation, and child key derivation. MPC nodes 104 with master key shares can work together to derive address paths into child key shares, for child address creation and signing. Each MPC node 104 may receive input information including, for example, address path, MPC algorithm (e.g., TSS, ed25519), threshold (e.g., 2-out-3), master public key, etc.

The seeding may step occur prior to any address or signing requests as part of the MPC Distributed Key Generation (DKG) process. This step may ensure that master key shares are securely distributed to the MPC nodes 104. In some embodiments, the air-gapped laptop (shown in FIG. 4) may be a dedicated system operated by the security officers for securely generating and seeding key shares. The seeding process may be conducted directly between the air-gapped laptop and the MPC nodes 104 via a secure, offline process instead of through the wallet service 102 to ensure confidentiality and integrity.

The “air-gapped laptop” example embodiment may be operated by the security officers during the initial key setup process to securely generate the master key, prepare shares, and distribute them to the TPMs of the MPC nodes 104. This key generation and seeding process may be distinct from the regular transaction signing workflows (e.g., distinct from FIG. 2 and FIG. 3) which occur during normal system operations.

HD wallet addresses may be supported in, for example, a tree structure. In general, the first few levels of address path can align to BIP44 specification, and may be specific and required to be hardened derivation, including purpose, coin_type, and account. The application may optionally define from the address index level, which could be extended to multiple levels. For example, to fit in a crypto custodian case regarding various wallet types, the single address index (defined in BIP44 standard) can be extended to support multiple levels at the end of address path string. So the resulted address path may include, for example, “m/purpose′/coin_type′/account′/change/wallet_type/wallet_index/address_index” and the original address index level can replaced by three consecutive new levels including: wallet_type, wallet_index, address_index.

In order to support multiple wallet types for the custody related systems and methods described herein, the address index can be split into three levels: wallet_type, wallet_index, and address_index. Such structure may support the custody service to allocate multiple warm wallets for example, and may support wallet recovery tools to scan the space sequentially. Hardened key derivation may be applied to some top levels until reaching account level (inclusively), while change and address_indices levels may not be non-hardened.

Other custodians may categorises wallets into different types: warm, hot, cold. Warm wallets can be used for incoming funds only, hot wallet for outgoing fund transfer, and cold wallet for storing fund in segregated place without online access.

TABLE 2
Example address path format

| | m / purpose‘ / coin_type′ / account′ / change / | hardened or |
|---|---|---|
| Address path | {address_indices} | normal |
| m | for master private key | — |
| purpose | := 44 always | hardened |
| coin_type | Different Blockchains | hardened |
| account | := [0 ... 2\hat{ }31-1] to identify tenant. | hardened |
| change | := [0, 1], reserved as 0 for non-bitcoin network | normal |
| address_indices | := wallet type / wallet index / address index | — |
| wallet_type | := [0 ... 2\hat{ }31-1] for IN/OUT/etc | Normal |
| wallet_index | := [0 ... 2\hat{ }31-1]. | Normal |
| address_index | := [0 ... 2\hat{ }31-1]. | normal |

One example path in format may include: m/44′/397′/0′/0/0/0/0

As noted, MPC provides different example functions or services: MPC DKG and MPC signing (e.g. transaction signing or message signing). As shown in FIG. 4, all the MPC nodes 104 can initially receive seed share and then collectively participate in master key generation. After DKG completes, each MPC node 104 may get its own master key share from master seed shares. A by-product, master xPUB, may be obtained from DKG as well. xPUB can be extended public key data which can be used for verification. Each MPC node 104 then can run a key derivation algorithm independently by integrating address path information with master key share. A threshold number of nodes can be set for signing. The key share may provide a private key for the MPC node 104 to use for transaction signing. The hierarchical key generation uses different key shares linked to the same master key for efficient storage and recovery. As noted, HD wallets provide a mechanism to generate multiple private keys deterministically from a single master key. That way the system only needs to backup the master key and later can restore all derived keys given the single master key. All derived keys can be organized into a hierarchical tree structure containing multiple address indices.

The MPC node 104 uses its key share to generate a derived key share for transaction signing by MPC sign. The MPC node 104 uses the derived key share to generate a signature for signing transactions. The MPC node 104 can provide the signature to other subsystems or services for signing transactions.

### MPC Signing

In accordance with some embodiments, <t>-out-of-<n> MPC nodes 104 (e.g., 2-out-of-3) may be needed to collectively generate a valid signature given the transaction hash. MPC protocol design, for example, may refer to GG series protocol for different elliptic curves including, for example, ECDSA, EdDSA, Schnorr. The distributed signing is another core functionality covered by MPC protocol. It is run on input M (the hash of the transaction payload being signed) and the output of a DKG protocol. MPC signing does not require involvement of all parties. Any subgroup of size t can generate a valid signature, in the example case t=2. Before signing, all three MPC nodes 104 may need to have already generated shares of the secret key x with threshold t=2 via DKG protocol. Then there can be two MPC nodes 104 chosen for signing. To sign a message, firstly two MPC nodes 104 can generate secret shares of random values. Then they can apply a so-called MtA (Multiplication to Addition) protocol to exchange public share information. Next each MPC node 104 can combine those received public shares and own private share to further compute signature shares. Those signature shares can be finally collected by each involved MPC node 104 and consolidated into a complete signature.

The service node 102 can choose different MPC nodes 104 to fulfil transaction signing. In some embodiments, a round-robin based MPC threshold selection may be used. Round-robin selection may ensure balanced load distribution across MPC nodes 104. By rotating requests evenly among the available nodes 104, round-robin prevents overburdening specific nodes 104 and allows for optimal use of system 100 resources. This approach may also provide fault tolerance, as any node 104 that fails to respond in a timely manner can be bypassed without disrupting the threshold signing process. Efficiency can be achieved by maintaining a predictable and evenly distributed workflow across the system.

### Description of PKI Scheme

The systems and methods described herein may use a Public Key Infrastructure (PKI) with a public Blockchain involved in message authentication and encryption.

In some embodiments, the systems and methods may use node registration. A Blockchain can be used for storage of all nodes' public keys. Each node 102, 104 may be required to register its public key to the Blockchain, so any other peer can download the key for authenticated message communication. The node stores its secret key share and private key in its secure hardware.

In some embodiments, on-chain mutual authentication can be used. MPC PKI may refer to Public Key Infrastructure for the MPC system 100 consisting of MPC nodes 104 and an MPC server. In the native custody context, the MPC server role can be taken by a service node 102. In the context of MPC, native custody refers to the secure management and control of digital assets without relying on a single point of failure. MPC PKI can be introduced into native custody for the purpose of authenticating messages between each MPC node 104 and service node 102. Specifically, MPC node 104 can sign all outgoing messages using its own private key while verifying the incoming messages from service node 102. The service node 102 can do likewise. The verification process may only require a peer's public key. There may be no direct communication among MPC nodes 104.

In some embodiments, end-to-end encryption can be used. The service node 102 in the system 100 may play the role of a non-trusted dealer to coordinate all MPC nodes 104 to complete the MPC protocol. The service node 102 can assign MPC nodes 104 for protocol sessions by routing requests evenly across available nodes 104, using a load-balancing approach like round-robin. This ensures balanced utilization while meeting threshold requirements (e.g., 2-out-of-3 for signing). The assignment process can prioritize availability and redundancy for efficiency and fault tolerance.

The system 100 may require that all messages among MPC nodes 104 be routed through the service node 102. Routing messages through the service node 102 can centralize communication which can enable session coordination and message routing without compromising security. Since all messages are end-to-end encrypted, the service node 102 cannot access the message content which can ensure confidentiality. This design can improve scalability and simplify orchestration while maintaining message security. Routing messages through the service node 102 obviates the need for the MPC nodes 104 to communicate directly and consequently manage peer-to-peer connections and coordination. Accordingly, routing messages through the service node 102 may improve the simplicity of session orchestration, reduce network overhead, and improve scalability. Furthermore, Additionally, the service node 102 can better handle node failures and maintaining a consistent protocol state across nodes 104.

In order to keep the service node 102 from eavesdropping on the messages, the encryption can be applied to all the messages originating from one MPC node 104 and destinating to another MPC node 104, namely, end-to-end encryption. The service node 102 can take two roles: service coordinator and message router, in a centralized way. By such design the system 100 may enjoy high scalability without sacrificing message security. In some embodiments, it may still be the service node 102 that actually triggers an MPC protocol session and collects the signing result finally.

In some embodiments, there may be one service node 102 per deployment of the system 100 to manage and coordinate all MPC sessions centrally. A service node 102 can be dedicated to its role and may not act as an MPC node 104 in any session, ensuring clear separation of responsibilities for security and operational integrity.

### PKI Message Structure

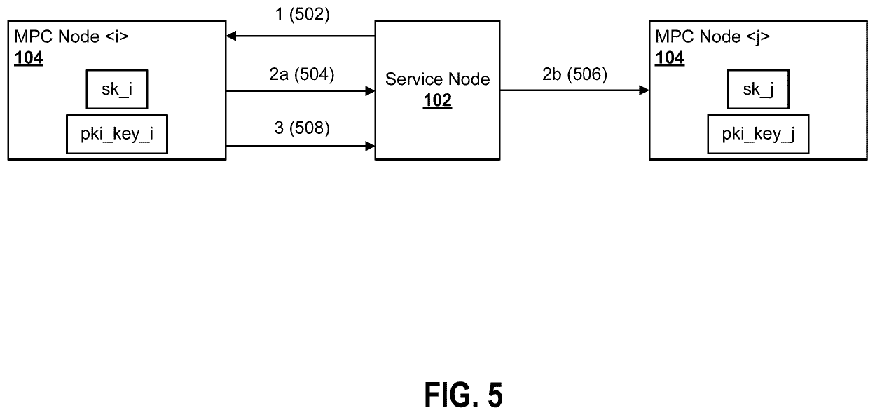

FIG. 5 shows a schematic diagram of Public Key Infrastructure (PKI) messages, according to some embodiments.

An example message may include:
Message:=Source|Destination|EncryptedData|MAC
EncryptedData:=encrypt (key=pki_pub_dest, data=Payload)
Payload:=Raw MPC Message
MAC:=sign (key=pki_key_source, data=Payload)

As shown, there may be, for example, four message types: Type-1 (502), Type-2a (504), Type-2b (506), and Type-3 (508).

Type-1 (502) may include messages initiated by Service Node 102 and ended on MPC node 104.

Type-2a (504) may include messages created by MPC node <i> 104 target to another MPC node <j> 104 but forwarded by Service Node 102.

Type-2b (506) may include messages forwarded by Service Node 102 in a transparent way.

Type-3 (508) may include messages created by MPC node 104 and target for Service node 102 for sending result.

In some embodiments, the service node 102 upon a user request (e.g. a request from wallet application on user device 10) may create a set of request messages (Type-1; 502), targeting for a set of MPC nodes 104. Each request message can be signed with the service node's 102 PKI private key, and encrypted by receiver MPC node's PKI public key.

In some embodiments, the service node 102 may receive intermediate message (Type-2a; 504) from MPC node 104. Then it can read header information including source and destination, and determine which MPC node 104 to further forward the message to (Type-2b; 506). The message may be verified against source MPC node 104 PKI public key, but there may be no decryption feasible. In such a PKI mechanism designed for MPC nodes 104 each message may be encrypted by using counter-party's public key, and the receiver may be specified in message header. As a result only the designated party may be able to decrypt the message because it owns the private key. The service node 102 though standing in the middle, may still be unable to decrypt all those messages destined to MPC node 104 on another end. For example, the service node 102 can use the signature of the message to locate the PKI public key of the MPC node 104 to verify the message given that the PKI private key of the MPC node 104 is used to sign the message. The MPC node 14 is assigned a PKI public key and a PKI private key. The PKI public key of the MPC node 104 is registered on the blockchain. The MPC node 14 can register on the blockchain 106 to access PKI public keys of peer nodes 104.

In some embodiments, the service node 102 may receive a resulting message (Type-3; 508) from the MPC node 104. Then it can, for example, firstly verify the message source, and then use its own PKI private key to decrypt the message to get result.

In some embodiments, MPC nodes 104 may work in a passive way by listening any request from Service node 102. Upon receiving a request, an MPC node 104 may try to decrypt the request message using its own PKI private key (and of course with verification). The MPC node 104 may also construct Type-2a messages pending on service node 102 to forward, or Type-3 message for sending result.

System 100 can support verification of signed messages, and the message protocol between nodes can be secured with signed messages. An MPC node 104 can be assigned a private key and a public key. The public key can be registered on the blockchain 106 that is accessible to other nodes 104 and services. Each MPC node 104 can register with the blockchain to access the public key of its peers. A sender node 104 can use its private key to sign a message and the signature (of the signed message) can identify the sender node 104. The recipient node 104 can use the signature (of the signed message) to locate the public key of the sender node 104 to verify the signed message.

In an aspect, there is provided a computer system 100 for digital asset custodian that integrates off-chain multi-party computation (MPC) signing with on-chain party identity authentication. The computer system 100 includes a service provider node 102, a plurality of computation nodes 104, and blockchain infrastructure 106 accessible to all participating nodes. Each of the plurality of computation nodes 104 having robust secure hardware and/or secure, tamper-resistant hardware.

In some embodiments, a computation node 104 stores a key share (e.g., an MPC key share) and a private key (e.g., a PKI private key) in its secure hardware, wherein the blockchain 106 stores a public key for the computation node 104, a location for the key share for the computation node 104, and a location for the private key for the computation node 104, the location referencing the computation node 104.

In some embodiments, the system further includes a user device 10 having an wallet application. The service node 102 provides a wallet service for the wallet application. The wallet service providing key generation and signing.

In some embodiments, the user device 10 transmits an address creation request to the service node 102 and receives an address creation response from the service node. The address creation response includes a wallet address. The service node 102 relays the request to the computation nodes to generate the wallet address using MPC DKG.

In some embodiments, the user device 10 transmits a transaction signing request to the service node 102 and receives a transaction signing response from the service node 102. The transaction signing request includes a transaction hash and wallet address. The transaction signing response includes a signed transaction. The service node 102 relays the request to the computation nodes 104 to generate a signature for the signed transaction.

In some embodiments, the nodes 104 deliver a threshold signing service with security to ensure that no single node 104 can recover the private key, while simultaneously recording and mutually authenticating each node's identity on-chain.

In some embodiments, the service provider node 102 implements hierarchical address creation and signing using an enhanced MPC protocol.

In some embodiments, the quantity of computation nodes 104 scales and the system uses efficient communication in response to the demands of the MPC protocol.

In some embodiments, the blockchain infrastructure 106 executes the MPC protocol delivering secure and efficient custodian functions such as key management and message signing.

In some embodiments, the private keys or key shares are stored in secure enclaves on each node 104, with relevant public keys registered on the verifiable blockchain infrastructure.

In some embodiments, the service provider node 102 implements protocol coordination, message routing, and service provision to enhance transparency. The service provider node 102 can enhance the transparency of the system 100 by acting as a centralized coordinator for protocol execution, message routing, and service provision. It can ensure that all interactions between components, such as the MPC nodes 104, are properly tracked and auditable. For example, by routing all protocol messages between MPC nodes 104, the service provider node 102 maintains a complete record of inter-node communications, ensuring clear traceability of operations (e.g., Message Routing and Logging) Further, the service provider node 102 can orchestrate sessions such as Distributed Key Generation (DKG) or transaction signing, ensuring that each step is systematically logged and can be reviewed (e.g., Protocol Coordination). The centralized nature of the service provider node 102 can allow for the generation of logs that can be used for audits, enhancing accountability across the system (e.g., Auditability). This transparency can ensure operational clarity and provide stakeholders with verifiable insights into system activities, supporting compliance, and trust in the system.

In some embodiments, the system 100 provides security through verified identities and end-to-end encryption for all inter-entity communications.

In some embodiments, the system 100 provides a scalable and efficient communication design of the MPC TSS protocol.

In some embodiments, the system 100 uses a trustless dealer.

In some embodiments, the system 100 supports HD standard-compatible wallets within the MPC protocol.

In some embodiments, the system 100 provides publicly retrievable identities on-chain for all nodes 102, 104.

In some embodiments, the system 100 uses authenticated and non-tamperable protocol messages.

In some embodiments, the service node 102 is implemented by a processing system that includes one or more processors and one or more memories coupled with the one or more processors, the one or more memories storing instructions for the off-chain MPC signing with on-chain party identity authentication.

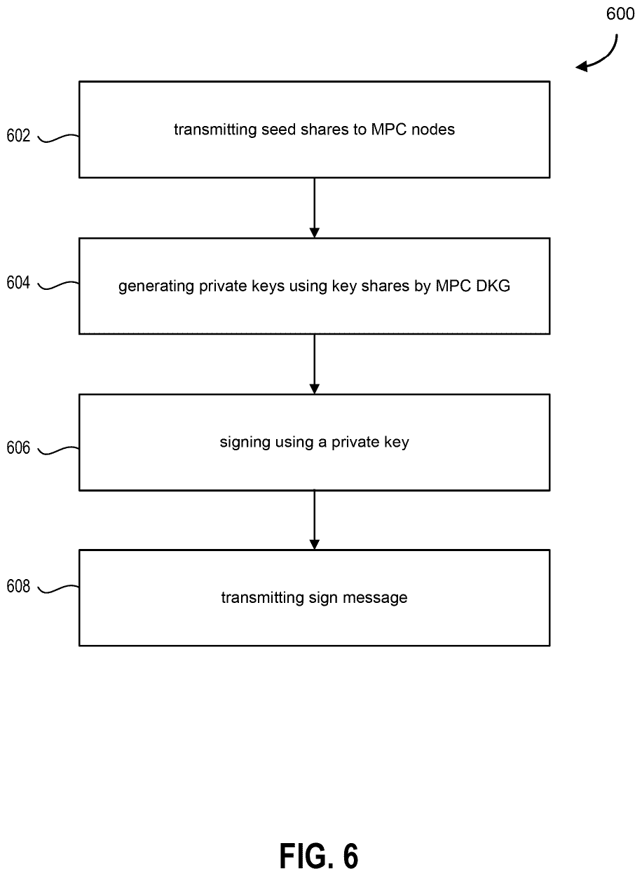

FIG. 6 illustrates an example method for a secure multi-party computation (MPC) threshold signature scheme (TSS), according to some embodiments. The method 600 integrates off-chain multi-party computation (MPC) signing with on-chain party identity authentication.

At 602, service node 102 transmits seed shares to the computation nodes equipped with robust secure hardware and/or secure, tamper-resistant hardware. The seed shares are derived from a master seed.

At 604, a computation node 104 generates a key share and a private key using MPC DKG and its seed share. The computation node 104 stores the key share and private key in its robust secure hardware and/or secure, tamper-resistant hardware. The key shares are organized into a hierarchical tree structure containing multiple address indices. The computation node 104 registers its corresponding public key on the blockchain 106. The blockchain 106 stores a public key for the computation node, a location for the key share for the computation node, and a location for the private key for the computation node. The location for the key share and location for the private key references the computation node 104 (with secure hardware).

At 606, the service 102 signs a message or transaction using a signature generated by combining signature shares of the computation nodes 104 by MPC signing.

At 608, the signed message or transaction is transmitted to the user device 10.

For example, the user device 10 transmits an address creation request to the service node 102 and receives an address creation response from the service node 102. The address creation response can include a wallet address. The service node 102 relays the request to the computation nodes 104 to generate the wallet address using MPC DKG.

As another example, the user device 10 transmits a transaction signing request to the service node 102 and receives a transaction signing response from the service node 102. The transaction signing request can include a transaction reference and wallet address. The transaction signing response includes a signed transaction or message. The service node 102 relays the request to the computation nodes 104 to generate a signature for the signed transaction.

In an aspect, there is provided a computer implemented method for digital asset custodian that integrates off-chain multi-party computation (MPC) signing with on-chain party identity authentication. The method including transmitting, by a service node, seed shares to a plurality of computation nodes equipped with robust secure hardware and/or secure, tamper-resistant hardware (block 602), generating, at each of the plurality of computation nodes, a key share and a private key using MPC DKG and storing the key share and private key in the robust secure hardware and/or secure, tamper-resistant hardware of the respective computation node (block 604), registering corresponding public keys on a blockchain, signing, at a computation node of the plurality of computation nodes, a message or transaction using a signature generated by combining signature shares of the computation nodes by MPC signing (block 606), and transmitting the signed message or transaction (block 608). The key shares are derived by the service node from a master seed. All key shares are organized into a hierarchical tree structure containing multiple address indices.

In an aspect, there is provided a computer implemented method for digital asset custodian that integrates off-chain multi-party computation (MPC) signing with on-chain party identity authentication. The method includes transmitting, by a service node, seed shares to a plurality of computation nodes each equipped with secure, tamper-resistant hardware (block 602), generating, at each of the plurality of computation nodes, a key share and a private key using MPC DKG and storing the key share and private key in the robust secure hardware of the respective computation node (block 604), storing, on a blockchain for a respective computation node, a public key for the computation node, a location for the MPC key share for the computation node, and a location for the PKI private key for the computation node, signing, at a computation node of the plurality of computation nodes, a message or transaction using a signature generated by combining signature shares of the computation nodes by MPC signing (block 606), and transmitting the signed message or transaction (block 608). Each of the plurality of computation nodes stores an MPC key share and a PKI private key in its secure, tamper-resistant hardware. The MPC key share is derived by the service node from a master seed. All key shares are organized into a hierarchical tree structure containing multiple address indices.

In some embodiments, the method further includes providing, by the service node, a wallet service for a wallet application on a user device for providing key generation and signing, receiving an address creation request and providing an address creation response, the address creation response comprising a wallet address, and relaying, by the service node, the request to the computation nodes to generate the wallet address using MPC DKG.

In an aspect, there is provided a non-transitory machine readable medium having stored thereon a plurality of instructions that, when executed by at least one computing device, cause the at least one computing device to perform the method for digital asset custodian that integrates off-chain multi-party computation (MPC) signing with on-chain party identity authentication. The method includes transmitting seed shares to a plurality of computation nodes equipped with secure, tamper-resistant hardware (block 602), generating, at each of the plurality of computation nodes, a key share and a private key using MPC DKG and storing the key share and private key in the robust secure hardware of the respective computation node (block 604), signing, at a computation node of the plurality of computation nodes, a message or transaction using a signature generated by combining signature shares of the computation nodes by MPC signing (block 606), and transmitting the signed message or transaction (block 608). The key shares are derived by the service node from a master seed. All key shares are organized into a hierarchical tree structure containing multiple address indices.

### Additional System Details

The systems and methods described herein can relate to a distributed system carrying out MPC TSS protocol to provide custodian functions including key management and message signing securely and efficiently.

In some embodiments, the systems and methods described herein can provide a scalable and efficient communication design of the MPC TSS protocol. For example, by introducing a trustless dealer, the distributed system can achieve scalability without compromising efficiency.

In some embodiments, the system can seamlessly support HD standard-compatible wallets within the MPC protocol. This integration can enhance the versatility and applicability of custodian functions.

In some embodiments, the distributed system can provide publicly retrievable identities on-chain for all its components. This can ensure transparency and accountability in the custodian functions performed by each entity within the system.

In some embodiments, the system can inherently provide an assurance of security through authenticated and non-tamperable protocol messages. This robustness may safeguard against malicious activities, ensuring the integrity of communication within the MPC TSS protocol.

The system described herein may address a critical gap in existing HD standards, particularly in the unexplored realm of hardware, specifically TPM-related areas. The system described herein can recognize the significance of secure hardware storage in crypto custodianship, carving out a niche for on-chain account authentication within threshold signing services.

Different types of wallets serve distinct purposes, with cold wallets often designated for secure hardware storage. The systems and methods described herein may offer HD standards that may appreciate this crucial aspect. The introduction of on-chain account authentication may ensure a secure and streamlined collaborative approach for signing transaction messages among multiple parties.

An example inherent challenge in MPC protocols is the high communication cost, primarily due to the cryptographically intensive computation involved in verifying each other's results. In the context of the crypto custodian industry, the systems and methods described herein may modify the protocol by simplifying it through the introduction of on-chain account authentication. This strategic simplification may not only minimize communication requirements but also uphold system security, addressing a key pain point in the current MPC landscape. This approach ensures a delicate balance between efficiency and security.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein

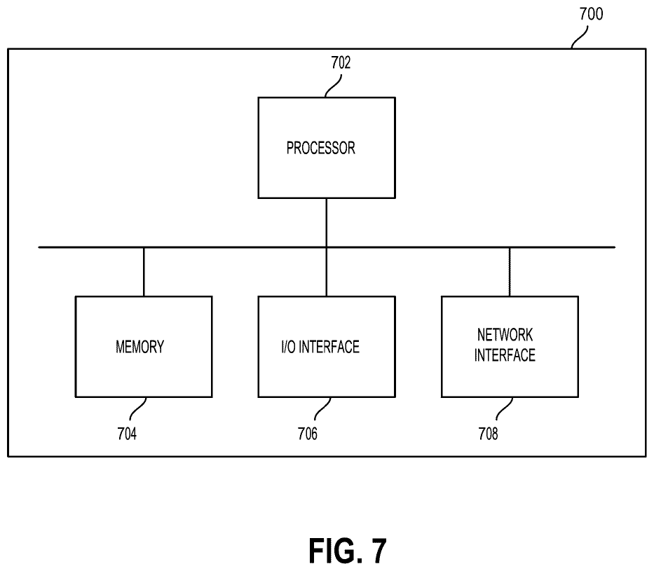

FIG. 7 is a schematic diagram of computing device 700, exemplary of an embodiment. As depicted, computing device 700 includes at least one processor 702, memory 704, at least one I/O interface 706, and at least one network interface 708.

For simplicity only one computing device 700 is shown but system may include more computing devices 700 operable by users to access remote network resources and exchange data. The computing devices 700 may be the same or different types of devices. The computing device 700 at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

Each processor 702 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 704 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 706 enables computing device 700 to interconnect with one or more input devices, such as a keyboard, mouse, camera, touch screen and a microphone, or with one or more output devices such as a display screen and a speaker.

Each network interface 708 enables computing device 700 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing device 700 is operable to register and authenticate users (using a login, unique identifier, and password for example) prior to providing access to applications, a local network, network resources, other networks and network security devices. Computing devices 900 may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

As can be understood, the examples described above and illustrated are intended to be exemplary only. The scope is indicated by the appended claims.

What is claimed is:

1. A computer system for digital asset custodian that integrates off-chain multi-party computation (MPC) signing with on-chain party identity authentication, wherein the computer system comprises: a service provider node, a plurality of computation nodes, and blockchain infrastructure accessible to all participating nodes, each of the plurality of computation nodes with secure, tamper-resistant hardware, wherein a computation node stores an MPC key share and a PKI private key in its secure hardware, wherein the blockchain stores a public key for the computation node, a location for the MPC key share for the computation node, and a location for the PKI private key for the computation node, the location referencing the computation node.

2. The system of claim 1 further comprising a user device having an wallet application, wherein the service node provides a wallet service for the wallet application, the wallet service providing key generation and signing.

3. The system of claim 2 wherein the user device transmits an address creation request to the service node and receives an address creation response from the service node, the address creation response comprising a wallet address, wherein the service node relays the request to the computation nodes to generate the wallet address using MPC DKG.

4. The system of claim 2 wherein the user device transmits a transaction signing request to the service node and receives a transaction signing response from the service node, the transaction signing request comprising a transaction hash and wallet address, the transaction signing response comprising a signed transaction, wherein the service node relays the request to the computation nodes to generate a signature for the signed transaction.

5. The system of claim 1 wherein the nodes deliver a threshold signing service with security to ensure that no single node can recover the private key, while simultaneously recording and mutually authenticating each node's identity on-chain.

6. The system of claim 1 wherein the service provider node implements hierarchical address creation and signing using an enhanced MPC protocol.

7. The system of claim 1 wherein the quantity of computation nodes scales and the system uses efficient communication in response to the demands of the MPC protocol.

8. The system of claim 1 wherein the distributed system, comprising a service node, computation nodes, and blockchain infrastructure, executes the MPC protocol, with the blockchain infrastructure facilitating the storage and verification of public keys, delivering secure and efficient custodian functions such as key management and message signing.

9. The system of claim 1 wherein the PKI private keys or MPC key shares are stored in secure enclaves on each node, with relevant public keys registered on the verifiable blockchain infrastructure.

10. The system of claim 1 wherein the service provider node implements protocol coordination, message routing, and service provision to enhance system transparency.

11. The system of claim 1 wherein the system provides security through verified identities and end-to-end encryption for all inter-entity communications.

12. The system of claim 1 wherein the system provides a scalable and efficient communication design of the MPC TSS protocol.

13. The system of claim 1 wherein the system uses a trustless dealer.

14. The system of claim 1 wherein the system supports HD standard-compatible wallets within the MPC protocol.

15. The system of claim 1 wherein the system provides publicly retrievable identities on-chain for all nodes.

16. The system of claim 1 wherein the system uses authenticated and non-tamperable protocol messages.

17. The system of claim 1 wherein the service node is implemented by a processing system that includes one or more processors and one or more memories coupled with the one or more processors, the one or more memories storing instructions for the off-chain MPC signing with on-chain party identity authentication.

18. A computer implemented method for digital asset custodian that integrates off-chain multi-party computation (MPC) signing with on-chain party identity authentication, the method comprising:
transmitting, by a service node, seed shares to a plurality of computation nodes each equipped with secure, tamper-resistant hardware, wherein each of the plurality of computation nodes stores an MPC key share and a PKI private key in its secure, tamper-resistant hardware, wherein the MPC key share is derived by the service node from a master seed;
generating, at each of the plurality of computation nodes, a key share and a private key using MPC DKG and storing the key share and private key in the robust secure hardware of the respective computation node, wherein all key shares are organized into a hierarchical tree structure containing multiple address indices;
storing, on a blockchain for a respective computation node, a public key for the computation node, a location for the MPC key share for the computation node, and a location for the PKI private key for the computation node;
signing, at a computation node of the plurality of computation nodes, a message or transaction using a signature generated by combining signature shares of the computation nodes by MPC signing; and
transmitting the signed message or transaction.

19. The method of claim 18, further comprising:
providing, by the service node, a wallet service for a wallet application on a user device for providing key generation and signing;
receiving an address creation request and providing an address creation response, the address creation response comprising a wallet address;
relaying, by the service node, the request to the computation nodes to generate the wallet address using MPC DKG.

20. A non-transitory machine readable medium having stored thereon a plurality of instructions that, when executed by at least one computing device, cause the at least one computing device to perform the method for digital asset custodian that integrates off-chain multi-party computation (MPC) signing with on-chain party identity authentication comprising:
transmitting seed shares to a plurality of computation nodes equipped with secure, tamper-resistant hardware, wherein the key shares are derived by the service node from a master seed;
generating, at each of the plurality of computation nodes, a key share and a private key using MPC DKG and storing the key share and private key in the robust secure hardware of the respective computation node, wherein all key shares are organized into a hierarchical tree structure containing multiple address indices;
signing, at a computation node of the plurality of computation nodes, a message or transaction using a signature generated by combining signature shares of the computation nodes by MPC signing; and
transmitting the signed message or transaction.
